(19) United States
(12) Patent Application Publication
(10) Pub. No.: US 2009/0231114 A1
(43) Pub. Date: Sep. 17, 2009

(54) PROGRAMMABLE TIRE PRESSURE DETECTOR

(76) Inventor: Hung-Chih YU, Taichung (TW)

Correspondence Address: Hershkovitz & Associates, LLC, 2845 Duke Street, Alexandria, VA, 22314, US

(21) Appl. No.: 12/046,932

(22) Filed: Mar. 12, 2008

(51) Int. Cl. B60C 23/00

(52) U.S. Cl. 340/447

(57) ABSTRACT

A programmable tire pressure detector has a body, a programmable micro-controller, a sensor, a low-frequency receiver and a radio-frequency transceiver. The body is mounted inside a tire. The programmable micro-controller is mounted inside the body and has a programming interface protruding from the body. The sensor detects a tire pressure and a tire temperature inside the tire. Wherein, the programming interface is selectively connected to a programmer and receives setting signals and data formats form the programmer. Hence, the programmable tire pressure detector can be applied to different vehicles with writing different setting signals and the data formats in the programmable micro-controller.

### BACKGROUND OF THE INVENTION

1. Field of Invention

The present invention relates to a tire pressure detector, and more particularly to a programmable tire pressure detector that can be rewritten with different settings corresponding to different type of vehicles.

2. Description of the Related Art

With reference to FIG. 3, a conventional tire pressure detector (90) is mounted inside a tire of a vehicle and comprises a micro-control unit (MCU) (91), a sensor (94), a low-frequency receiver (92) and a radio frequency transceiver (93). The sensor (94) detects a tire pressure and/or an interior temperature therein. The low-frequency receiver (92) is electronically connected to the MCU (91) and receives a low-frequency signal from a tire pressure monitoring apparatus to input settings for the MCU (91). The radio frequency transceiver (93) is electronically connected to and controlled by the MCU (91) to transmit a RF signal corresponding to the tire pressure and/or the interior temperature to the tire pressure monitoring apparatus to notice a driver who drives the vehicle. However, each conventional tire pressure detector (90) is designed and is manufactured for a specific vehicle or a very limited kinds of vehicles only. Different tire pressure detector (90) is required for another kinds of vehicles, and this is troublesome and waste for manufacturers and service providers.

The present invention provides a programmable tire pressure detector to obviate or mitigate the shortcomings of the conventional tire pressure detector.

### SUMMARY OF THE INVENTION

The primary objective of the present invention is to provide a programmable tire pressure detector that is rewriteable for new settings corresponding to various vehicles to reduce costs for manufactures and service providers.

The programmable tire pressure detector has a body, a programmable micro-controller, a sensor, a low-frequency receiver and a radio-frequency transceiver. The body is mounted inside a tire. The programmable micro-controller is mounted inside the body and has a programming interface protruding from the body. The sensor detects a tire pressure and a tire temperature inside the tire. Wherein, the programming interface is selectively connected to a programmer and receives setting signals and data formats form the programmer. Hence, the programmable tire pressure detector can be applied to different vehicles with writing different setting signals and the data formats in the programmable micro-controller.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a programmable tire pressure detector in accordance with the present invention;

FIG. 2 is an operational top view of a car with the programmable tire pressure detector in FIG. 1; and

FIG. 3 is a block diagram of a conventional tire pressure detector in accordance with the prior art.

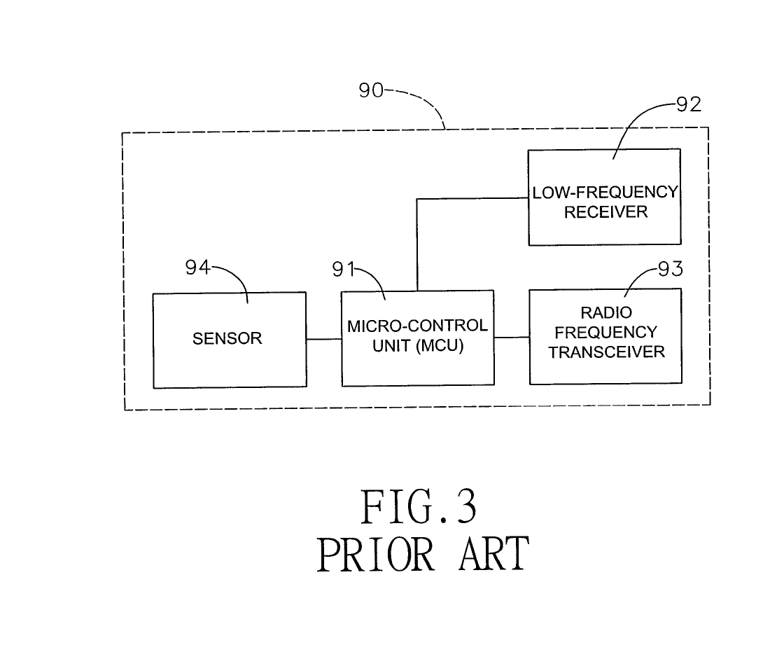

### DETAILED DESCRIPTION OF THE INVENTION

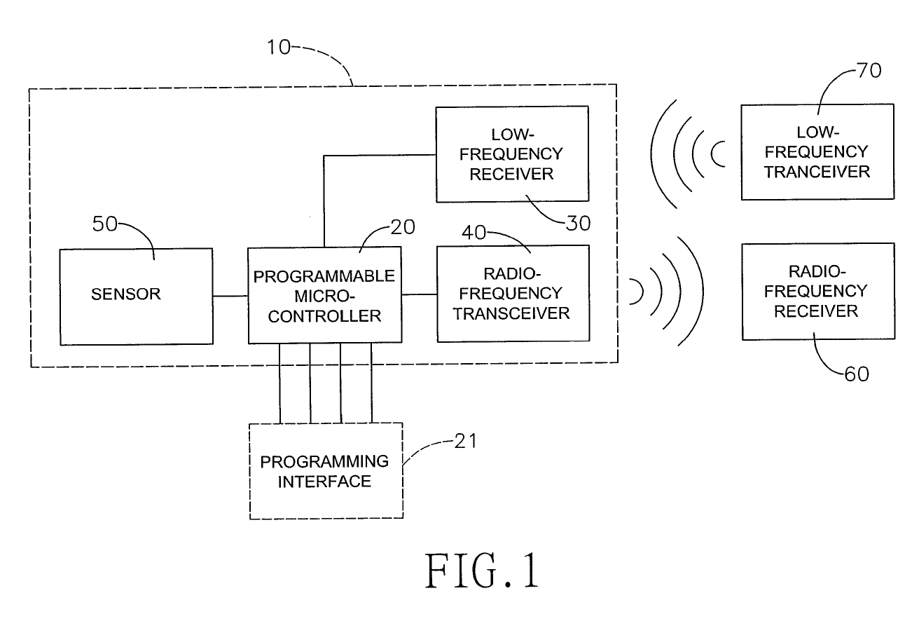

With reference to FIG. 1, a programmable tire pressure detector in accordance with the present invention comprises a body (10), a programmable micro-controller (20), a sensor (50), a low-frequency receiver (30) and a radio-frequency transceiver (40).

The body (10) is mounted securely inside a tire of a vehicle and may be mounted on a valve stem being mounted on a rim of the tire.

The programmable micro-controller (20) is mounted inside the body (10) and is capable of rewriting settings and data formats thereof and has a programming interface (21). The programming interface (21) protrudes from the body (10) and is capable of connecting to a programmer and receives setting signals from the programmer to rewrite the setting signals in the programmable micro-controller (20).

The sensor (50) is electronically connected to the programmable micro-controller (20), detects a tire pressure and/or a tire temperature inside the tire and sends the tire pressure and/or the tire temperature to the programmable micro-controller (20).

The low-frequency receiver (30) is electronically connected to the programmable micro-controller (20) and receives commands from a low-frequency transceiver (70) of a monitoring system (80) mounted inside the vehicle.

The radio-frequency transceiver (40) is electronically connected to and is controlled by the programmable micro-controller (20) to send radio-frequency signals corresponding to the tire pressure and/or tire temperature to a radio frequency receiver (60) of the monitoring system (80) mounted inside the vehicle.

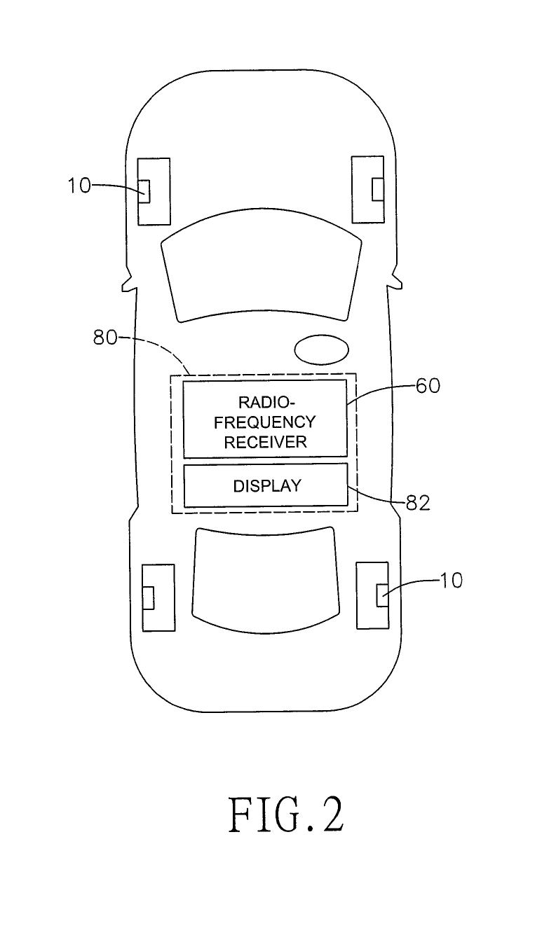

With reference to FIG. 2, when the monitoring system (80) receives the radio-frequency signals from the radio-frequency transceiver (40), the monitoring system shows the detected tire pressure and/or the tire temperature on a display (82) to notice a driver.

Because the programmable micro-controller (20) is programmable and is capable of connecting with the programmer by the programming interface (21), different settings and data formats for various vehicles may be written in the programmable micro-controller (20). Hence, the programmable tire pressure detector in accordance with the present invention can be applied for different kinds of vehicles after rewriting suitable settings and data formats for corresponding vehicles.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A programmable tire pressure detector comprising:
a body;
a programmable micro-controller being mounted inside the body, being capable of rewriting settings and data formats thereof and having
a programmable interface protruding from the body and receiving setting signals to rewrite the setting signals in the programmable micro-controller;
a sensor being electronically connected to the programmable micro-controller for detecting a tire pressure and sending the tire pressure to the programmable micro-controller;
a low-frequency receiver being electronically connected to the programmable micro-controller and receiving low-frequency signals; and
a radio-frequency transceiver being electronically connected to the programmable micro-controller and being controlled by the programmable micro-controller to send out radio-frequency signals corresponding to the tire pressure.

2. The tire pressure monitoring system as claimed in claim 1, wherein the sensor is a temperature sensor for detects tire temperatures therein.
